(19) United States
(12) Patent Application Publication
(10) Pub. No.: US 2007/0254122 A1
(43) Pub. Date: Nov. 1, 2007

(54) POLYPROPYLENE RESIN COMPOSITION AND MOLDED ARTICLES, SHEET OR CONTAINER THEREFROM

(75) Inventors: Norihide Inoue, Nagoya-shi (JP); Takayuki Kuroki, Chiba-shi (JP)

Correspondence Address: FOLEY AND LARDNER LLP;SUITE 500, 3000 K STREET NW, WASHINGTON, DC, 20007, US

(73) Assignee: Mitsui Chemicals, Inc.

(21) Appl. No.: 11/687,155

(22) Filed: Mar. 16, 2007

(30) Foreign Application Priority Data
Mar. 17, 2006 (JP) 2006-073965

(51) Int. Cl. C08L 23/12; B29D 22/00; B32B 27/32

(52) U.S. Cl. 428/35.7; 428/220; 525/240

(57) ABSTRACT

An object of the present invention is to provide a propylene resin composition capable of providing a thermoformed container excellent in heat resistance, moldability, appearance and shape, and a molded article obtained by bending processing a polypropylene resin composition excellent in heat resistance and shape retention property in bending processing. An object of the present invention is to provide a polypropylene resin composition comprising 50 to 99% by weight of a propylene polymer (A) having a meting point (Tm) in the range of 140 to 170° C. as measured by a differential scanning calorimeter and 1 to 50% by weight of a propylene/α-olefin copolymer (B) having a melting point (Tm) of 100° C. or less or having no observed melting point, a molded article and a sheet obtained therefrom, and a container obtained by thermoforming the sheet.

### BACKGROUND OF THE INVENTION

1. Field of the Invention

The present invention relates to a polypropylene resin, composition, and in particularly to a resin composition capable of providing a molded article which is good in appearance and shape and further relates to a sheet and a container obtained therefrom.

2.Background of the Invention

A crystalline polypropylene has excellent in mechanical properties such as tensile strength, rigidity, surface hardness, impact resistant strength and cold resistance, optical properties such as gloss and transparency or food hygienic properties such as nontoxicity and odorless properties, and is widely used especially in the field of food packaging.

Such crystalline polypropylene is molded by bending process to use as various molded articles, or is molded in a sheet form and further softened by heating and then molded in a container shape, that is to say, is thermally molded into a cup or a tray shape, for example, as a container for food packaging to use.

Some containers obtained from such crystalline polypropylene are used for the applications requiring transparency in order to visually confirm the contents. However, when a crystalline polypropylene sheet is bend-processed or thermally molded, there is a problem that blanching of the sheet occurs to produce an opaque container, and thus prevention of blanching is desired.

In Japanese Patent Laid-Open Publication No. H10-212382, there is disclosed a technique in which the blanching of a molded article is prevented in the falling weight impact test of the square plate obtained by injection molding a polypropylene resin composition comprising an ethylene-based random copolymer and a propylene/1-butene random copolymer. However, no description is given on the thermoforming.

Further, in Japanese Patent Laid-Open Publication No. H10-67896, there is disclosed a polypropylene resin composition for a sheet comprising a crystalline propylene/ethylene random copolymer and a propylene/butene copolymer rubber. However, there is a problem that sufficient heat resistance is not obtained.

### SUMMARY OF THE INVENTION

The present invention provides a polypropylene resin composition capable of providing a molded article or a container which are excellent in moldability and good in appearance and shape on bending molding and thermoforming, and a molded article, a sheet and a container obtained by molding the polypropylene resin composition.

As a result of earnest studies to solve the above problems, the present inventors have found that it is possible to obtain a molded article, a sheet and a container which are excellent in moldability and good in appearance and shape in bend molding and thermoforming by the use of a specific polypropylene resin composition and to solve the problems, and have completed the present invention.

In other words, the present invention is a polypropylene resin composition comprising 50 to 99% by weight of a propylene polymer (A) having a melting point (Tm) in the range of 140 to 170° C. as measured by a differential scanning calorimeter and 1 to 50% by weight of a propylene/α-olefin copolymer (B) having a melting point (Tm) of 100° C. or less or having no observed melting point.

And further, the present invention is a molded article molded from the polypropylene resin composition, a sheet having a thickness in the range of 0.05 to 5 mm and a container obtained by thermoforming of the sheet.

Further, the present invention is a polypropylene resin composition having a return angle (θ degree) of 30 degree or less when force is released after bending and holding for 5 minutes a sheet having a thickness of 0.6 mm obtained by molding the polypropylene resin composition at an angle of 90 degree at room temperature.

And further, the present invention is a molded article obtained by bending processing of the polypropylene resin composition.

The polypropylene resin composition of the present invention can provide a molded article excellent in moldability, heat resistance and transparency in producing a molded article.

A molded article, especially a sheet obtained from the polypropylene resin composition of the present invention can prevent the occurrence of blanching in further thermoforming it, thereby providing a thermally molded container excellent in transparency.

Further, the polypropylene resin composition of the present invention is excellent in shape retention property in bending processing.

### BRIEF DESCRIPTION OF THE DRAWINGS

FIG. 1 shows a method for bending processing in order to evaluate the shape retention property which conducted in Examples and Comparative Examples of the present invention. θ means a return angle.

### DESCRIPTION OF THE PREFERRED EMBODIMENT

The polypropylene resin composition of the present invention comprises 50 to 99% by weight of a propylene polymer (A) having a melting point (Tm) in the range of 140 to 170° C. as measured by a differential scanning calorimeter and 1 to 50% by weight of a propylene/α-olefin copolymer (B) having a melting point (Tm) of 100° C. or less or having no observed melting point.

[Propylene Polymer (A)]

The propylene polymer (A) used as a constituent unit of the polypropylene resin composition of the present invention may contain, in addition to the constituent unit derived from propylene, a constituent unit selected from an α-olefin except for propylene (the α-olefin except for propylene refers to an α-olefin including ethylene except for propylene). Moreover, when the propylene polymer (A) contains a constituent unit derived from an α-olefin except for the constituent unit derived from propylene, it may contain one kind or two or more kinds of α-olefins. Specifically, the propylene polymer (A) preferably is a propylene homopolymer or is a random copolymer or a block polymer of propylene and an α-olefin selected from an α-olefin except for propylene.

Further, the melting point (Tm) of the propylene polymer (A) measured by a differential scanning calorimeter (DSC), is in the range of 140 to 170° C., preferably 145 to 170° C. and more preferably 150 to 165° C. Furthermore, the content of the constituent unit derived from propylene in the propylene polymer (A) is 80 to 100 mol %, preferably 85 to 100 mol %, more preferably 90 to 100 mol %, further more preferably 96.5 to 100 mol %, especially preferably 100 mol %, that is, a homopolymer of propylene.

When the propylene polymer (A) is a copolymer, as the α-olefin except for propylene used as a constituent unit compound, there may be mentioned an α-olefin including ethylene and those having 4 to 20 carbon atoms, and preferably ethylene, 1-butene and 1-pentene. The constituent unit content derived from an α-olefin used for the copolymerization in the propylene polymer (A) is 0 to 20 mol %, preferably 0 to 15 mol %, more preferably 0 to 10 mol %, and further more preferably 0 to 3.5 mol %.

The melt flow rate (hereinafter, abbreviated as MFR) of the propylene polymer (A), as measured at 230° C. under a load of 2.16 kg in accordance with ASTM D123B, is 0.05 to 50 g/10 min., preferably 0.1 to 20 g/10 min.

Such propylene polymer (A) may be produced by polymerizing propylene or copolymerizing propylene with other α-olefin(s) by using a Ziegler catalyst system comprising a solid catalyst component containing magnesium, titanium, halogen and an electron donor as an essential component, an organic aluminum compound and an electron donor, or a metallocene catalyst system using a metallocene compound as a catalyst component, but may also be produced by other known methods.

[Propylene/α-Olefin Copolymer (B)]

The propylene/α-olefin copolymer (B) used in the present invention is a propylene/α-olefin random copolymer containing a constituent unit derived from propylene and a constituent unit derived from an α-olefin except for propylene (the α-olefin except for propylene refers to an α-olefin including ethylene except for propylene). Moreover, the constituent unit contained in the propylene/α-olefin copolymer (B) and derived from an α-olefin contains one kind or two or more kinds of α-olefins.

Further, the melting point (Tm) of the propylene/α-olefin random copolymer (B), as measured by DSC method (an endothermic peak observed when after holding at 200° C. for 5 minutes, the temperature is lowered to −20° C. at a temperature lowering rate of −20° C./min. and subsequently the temperature is again raised to 180° C. at a temperature rising rate of 20° C./min.), is 100° C. or less, preferably 40 to 95° C., more preferably 50 to 90° C. or a melting point is not observed when measured by the method.

The propylene/α-olefin random copolymer (B) can be obtained by copolymerizing propylene with at least one kind of α-olefin selected from α-olefins except for propylene by using a known stereoregular catalyst. Especially preferable is a propylene/α-olefin random copolymer copolymerized by using a metallocene catalyst because the molded article produced thereof is less sticky. In this case, the molecular weight distribution (Mw/Mn), as measured by gel permeation chromatography (GPC), is in the range of 1 to 3.

The α-olefin copolymerized together with propylene, except for propylene includes ethylene and α-olefin having 4 to 20 carbon atoms such as 1-butene or 1-pentene. Further, the constituent unit derived from an α-olefin contains one kind or two or more kinds of α-olefins. Specifically, preferably used are 1-butene or 1-butene and further α-olefin(s) except for 1-butene, but especially preferable is 1-butene.

The content of the constituent unit derived from propylene in the propylene/α-olefin random copolymer (B) is 50 to 95 mol %, preferably 65 to 90 mol %, more preferably 65 to 79 mol % and especially preferably 70 to 79 mol %. Further, the content of the constituent unit derived from α-olefin including ethylene and α-olefin having 4 to 20 carbon atoms is, for example, 5 to 50 mol %, preferably 10 to 35 mol %, more preferably 21 to 35 mol % and especially preferably 21 to 30 mol % (here the sum of the constituent unit derived from propylene and the constituent unit derived from an α-olefin including ethylene and α-olefin having 4 to 20 carbon atoms is 100%).

The propylene/α-olefin random copolymer (B) can be obtained by using a catalyst as described, for example, in the pamphlet of International Publication No. 2004/087775. Preferably used is a propylene/α-olefin random copolymer (B) in which the melting point (Tm) (° C.) and the content M (mol %) of the constituent unit derived from an α-olefin including ethylene and α-olefin having 4 to 20 carbon atoms as determined by ¹³C-NMR spectrum satisfy the following relationship (1):
146exp(−0.022 M)≧ ≧125exp(−0.032 M) (1)

The melt flow rate (MFR) of the propylene/α-olefin random copolymer (B), as measured at 230° C. under a load of 2.16 kg in accordance with ASTM D1238, is 0.1 to 50 g/10 min., and preferably 1 to 20 g/10 min.

[Polypropylene Resin Composition]

The polypropylene resin composition of the present invention comprises 50 to 99% by weight of the propylene polymer (A) and 1 to 50% by weight of the propylene/α-olefin copolymer (B). The polypropylene resin composition preferably comprises 60 to 99% by weight of the propylene polymer (A) and 1 to 40% by weight of the propylene/α-olefin copolymer (B), more preferably comprises 70 to 98% by weight of the propylene polymer (A) and 2 to 30% by weight of the propylene/α-olefin copolymer (B), and especially preferably 75 to 95% by weight of the propylene polymer (A) and 5 to 25% by weight of the propylene/α-olefin copolymer (B). If each component is blended at the above ratio, the polypropylene resin composition of the present invention is excellent in moldability, heat resistance and transparency and can be suitably used especially for thermoforming.

In the present invention, there may be contained other synthetic resins and rubbers if needed or additives such as antioxidants, heat stabilizers, weather stabilizers, slip agents, antiblocking agents, nucleating agents, pigments and hydrochloric absorbers and inorganic fillers so long as the performance as the polypropylene resin composition of the present invention is not impaired.

As the other synthetic resins, there may be contained, in addition to the propylene polymer (A) and the propylene/α-olefin copolymer (B), an ethylene homopolymer and an α-olefin copolymer of ethylene and α-olefin having 3 to 20 carbon atoms, wherein the α-olefin content is less than 50 mol %, but the embodiment containing no such polymers is preferable. Further, as the olefin polymer component contained in the composition, the composition preferably comprises only the propylene polymer (A) and the propylene/α-olefin copolymer (B) of the present invention (even in this case, there may be contained the above mentioned additives such as antioxidants, heat stabilizers, weather stabilizers, slip agents, antiblocking agents, nucleating agents, pigments and hydrochloric acid absorbers as well as inorganic fillers).

The polypropylene resin composition of the present invention may be used in a pellet form when necessary after blending each component and various additives by a mixer, for example, a Henschel mixer, a Banbury mixer and a tumbler mixer and then melting and kneading the mixture using a single screw or a twin-screw extruder. However, the polypropylene resin composition may be fed to a known molding machine such as a sheet molding machine and an injection molding machine in a blended form without melting and kneading the components.

Further, in the present invention, except for a method of blending each component, the polypropylene resin composition may be obtained by producing each component at the stage of polymerization, that is, a method of multi-stage polymerization.

Moreover, a sheet with a thickness of 0.6 mm is obtained by film-forming the polypropylene resin composition at a cylinder temperature of 210° C. and at a chill roll temperature of 30° C. using an extruder equipped with a T-die, and a haze of the sheet, as measured in accordance with ASTM D1003, is 60% or less, preferably 1 to 55%. If the value of the haze is within the range, the transparency is high and preferable.

Furthermore, the resin composition of the present invention has a deflection temperature under load of 80 to 150° C., preferably 80 to 120° C. and more preferably 90 to 110° C. The deflection temperature under load is measured under a load of 0.45 MPa in accordance with JIS K7191 using a test specimen with a length of 127 mm, a width of 12.5 mm and a thickness of 3.2 mm obtained by injection molding the polypropylene resin composition. If the deflection temperature under load is within the range, the resin composition is excellent in heat resistance.

In addition, the resin composition of the present invention has a return angle (θ degree) of 30 degree or less, preferably 0.1 to 30 degree, more preferably 0.1 to 20 degree, furthermore preferably 3 to 18 degree and especially preferably 3 to 13 degree. The return angle is measured in the following manner, that is, a sheet obtained by forming the polypropylene resin composition and having a thickness of 0.6 mm is bent and held at an angle of 90 degree at room temperature for 5 minutes, and then the force is released. When the return angle is within the range, the resin composition is excellent in shape retention property at bending processing.

[Film or Sheet]

A film or sheet of the present invention may be obtained by molding the polypropylene resin composition of the present invention into a film or sheet using extruder equipped with a T-die or a calendering-equipment used for molding a film or sheet of a usual polyolefin. Further, a film or sheet of the present invention has a thickness in the range of 0.05 to 5 mm, usually in the range of 0.1 to 3 mm.

A film or a sheet of the present invention may be stretched in a monoaxial or biaxial direction.

A film or sheet of the present invention may be a laminated film or laminated sheet which is laminated with a film or sheet comprising other resins or with a metallic foil, and there may be used a film or sheet comprising a polypropylene resin composition of the present invention in at least one layer of the laminated film or sheet.

Further, except for layers composed of a film or sheet comprising a polypropylene resin composition used in the case where a laminated film or sheet is constituted, other layers include a film obtained from polypropylene, polyethylene, polyimide and polyester, a stretched film thereof and a metallized film in which aluminum or a silicon compound is deposited on these films. When such complex laminated structure is constituted, there may be preferably used a known coextrusion method, such as a dry lamination method or an extrusion lamination method.

In addition, a film or a sheet of the present invention may be used as a metallized sheet that aluminum or a silicon compound is directly deposited on the film or sheet of the present invention or a stretched film or a sheet thereof.

Since the film or a sheet of the present invention is excellent in heat resistance, transparency, appearance and shape, it is suitably used, for example, for food packaging application or clothes packaging application and as packing and packaging materials.

[Container]

Since the container of the present invention is excellent in heat resistance, transparency, appearance and shape, it is suitably used as a container for food packaging of, for example, bean curd, jelly, dairy products such as yogurt or frozen foods, and a container used for the storage or transportation of such as electric parts or electronic components.

A container of the present invention may be obtained by thermoforming a film or sheet comprising the polypropylene resin composition of the present invention into a container shape.

The thermoforming refers to a process in which a film or a sheet comprising a thermoplastic resin is heat-softened and the shape is arranged while it is soft, and then it is cooled to produce a molded article (“Jitsuyo Plastic Yogo Jiten”, revised third edition, published by Plastics Age Co., Ltd.). As the thermoforming method, there may be adopted a known method in which a film or sheet comprising a thermoplastic resin is heat-softened, followed by molding into a die shape. As the molding method, there may be mentioned, for example, a method in which the film or sheet is molded into a die shape using vacuum or compressed air and further using a plug in combination as needed (such as a straight method, a drape method, an air-slip method, a snapback method or a plug-assist method), a method of press-molding the film or sheet.

Typically, a sheet is softened so that the sheet is heated to a temperature range from the glass transition temperature to the melting point, preferably from (melting point—50° C.) to the melting point. Subsequently, the sheet is pressed to a die using vacuum or compressed air or both of them and then cooled to obtain a thermoformed container.

Further, the shape of a container-includes shapes such various cups, trays, dishes and bowls.

[Molded Article]

Furthermore, a film or a sheet obtained from the polypropylene resin composition of the present invention may be bend-processed into a desired shape at room temperature or under a heating condition. For example, the film or sheet may be molded into a molded article of such a tray shape or a box shape. As the molded article, there may be specifically exemplified a box housing a cosmetic, a cake, a toy, a writing material, or sundry goods.

### EXAMPLES

Next, the present invention will be explained with reference to Examples, however, the present invention is not limited by these Examples.

[Measurements of Physical Properties of Propylene Polymer (A) and Propylene/1-Buten Random Copolymer (B)]

(1) Propylene Content and 1-Butene Content

The propylene content and 1-butene content were measured by ¹³C-NMR spectrum.

(2) Molecular Weight Distribution (Mw/Mn)

The molecular weight distribution (Mw/Mn) was determined by using GPC-150C manufactured by Millipore Corporation as follows.

A separation column (TSK GNH HT) having a diameter of 27 mm and a length of 600 mm at a column temperature of 140° C., and o-dichlorobenzene (Wako Pure Chemical Industries, Ltd.) and 0.025% by weight of 3,5-di-tert-butyl-4-hydroxytoluene (BHT; manufactured by Takeda Pharmaceutical Co. Ltd.) as an antioxidant for the mobile phase, were used. The mobile phase was delivered at a flow rate of 1.0 ml/min.; the sample concentration was set at 0.1% by weight; the injected amount of the sample was 500 μl; and a differential refractometer was used as a detector.

(3) Melting Point (Tm)

The melting point was measured by a DSC-7 type apparatus (a differential scanning type calorimeter (DSC)) manufactured by Perkin-Elmer Corporation. The melting point was determined from an endothermic curve obtained by heating approximately 5 mg of a sample filled in an aluminum pan to 200° C. and maintaining it at 200° C. for 5 minutes, then cooling it to −20° C. at a cooling rate of −20° C./min. and maintaining it at −20° C. for 2 minutes and subsequently heating it again at a rate of 20° C./min.

(4) Melt Flow Rate (MFR)

The melt flow rate was measured at 230° C. under a load of 2.16 kg in accordance with ASTM D1238.

[Physical Properties Measurements]

(1) Deflection Temperature Under Load

The deflection temperature under load was measured under a load of 0.45 MPa in accordance with JIS K7191 using a test specimen with a length of 127 mm, a width of 12.5 mm and a thickness of 3.2 mm obtained by injection molding a polypropylene resin composition.

(2) Total Haze of Sheet

The total haze of a sample of sheet with a thickness of 0.6 mm, which was obtained by film-forming a resin Composition at an extrusion temperature of 210° C. and at a chill roll temperature of 30° C. using a 50 mm diameter single screw extruder equipped with a T-die, was measured in accordance with ASTM D1003.

(3) Moldability of Sheet

When a sample of sheet having a thickness of 0.6 mm was formed by film-forming a resin composition at a cylinder temperature of 210° C. and at a chill roll temperature of 30° C. using a 50 mm diameter single screw extruder equipped with a T-die, the degree of stickiness of the sample to the chill roll was visually observed and the sample with good result was marked “◯”, and the sample with stickiness was marked “×”.

(4) Vacuum Moldability

When a sample of sheet obtained in the same way as the evaluation of the moldability of sheet in the above mentioned was vacuum molded by using a vacuum molder equipped with a cup-shaped die having a bore diameter of 80 mm and a depth of 40 mm manufactured by Asano Laboratories Co., Ltd., the softening state of the sample in preheating at a preheater temperature of 250° C. for 15 sec. was visually observed.

Further, the blanching state was also observed for a molded article obtained by vacuum molding under the conditions of a preheater temperature of 250° C., a preheating time of 15 sec., a die temperature of 20° C. and a residence time in the die of 10 sec. The sample without blanching was marked “⊚”, the sample with slight blanching was marked “◯” and the sample with blanching was marked “×”.

(5) Total Haze of Molded Article

By cutting out the bottom portion of a cup-shaped molded article obtained by vacuum molding a resin composition by using a vacuum molder equipped with a cup-shaped die having a bore diameter of 80 mm and a depth of 40 mm manufactured by Asano Laboratories Co., Ltd., the total haze of the bottom portion of the molded article was measured in accordance with ASTM D1003. The thickness of the bottom portion of the cup-shaped molded article cut out was 0.4 mm.

(6) Bending Workability (Shape Retention Property)

A sample of sheet with a thickness of 0.6 mm, which was obtained by film-forming a resin composition at an extrusion temperature of 210° C. and at a chill roll temperature of 30° C. using a 50 mm diameter single screw extruder equipped with a T-die, was cut out in a rectangular shape having a length of 200 mm and a width of 20 mm.

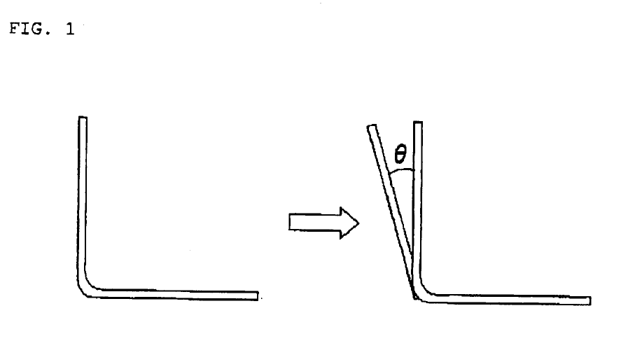

Next, a return angle (θ degree) was measured, the force is released after bending and holding the sample at an angle of 90 degree at room temperature for 5 minutes, as shown in FIG. 1. It shows that, the smaller return angle θ the sample has, it means the better shape property.

[Propylene Polymer (A)]

(A1) Propylene Homopolymer

Melting Point (Tm); 160° C., MFR (at a temperature of 230° C., under a load of 2.16 kg); 0.5 g/10 min.

(A2) Propylene/Ethylene Random Copolymer

Ethylene Content; 4.7 mol %, Melting Point; 142° C., MFR (at a temperature of 230° C., under a load 2.16 kg); 9 g/10 min.

[Propylene/α-Olefin Copolymer(B)]

(B1) Propylene/1-Butene Random Copolymer

In a 20-L polymerization apparatus thoroughly purged with nitrogen, were charged 8.7 L of dried hexane, 900 g of 1-butene and triisobutylaluminum (1.0 mmol) at room temperature. After the inside temperature of the polymerization apparatus was elevated to 65° C., propylene was fed until the pressure inside the apparatus became 0.7 MPa.

Subsequently, to the polymerization apparatus, a toluene solution in which 0.002 mmol of dimethylmethylene(3-tert-butyl-5-methylcyclopentadienyl)flu orenylzirconium dichloride and methylaluminoxane (manufactured by Tosoh Finechem Corp.) having 0.6 mmol equivalent of aluminum were brought into contact, and then the polymerization was performed for 30 minutes while keeping the inside temperature at 65° C. and the propylene pressure at 0.7 MPa, followed by addition of 20 ml of methanol to stop the polymerization.

After depressurizing, a polymer was precipitated from the polymerization solution in 20 L of methanol and dried under vacuum at 130° C. for 12 hours.

The resulting polymer had a weight of 130 g, a propylene content of 74 mol %, a butene content of 26 mol %, a melting point (Tm) of 75° C., an MFR (at a temperature of 230° C., under a load of 2.16 kg) of 7 g/10 min. and a molecular weight distribution (Mw/Mn) of 2.1. A required amount of the polymer was obtained by repeating the above operations.

(B2) Propylene/1-Butene Random Copolymer

(B2) was produced by the same method as the above method except that the added amounts of propylene and 1-butene were changed. The resulting polymer had a propylene content of 78 mol %, a butene content of 22 mol %, a melting point (Tm) of 83° C., an MFR (at a temperature of 230° C., under a load of 2.16 kg)of 7 g/10 min. and a molecular weight distribution (Mw/Mn) of 2.0.

(B3) Propylene/1-Butene Random Copolymer

(B3) was produced by the same method as the above method except that the added amounts of propylene and 1-butene were changed. The resulting polymer had a propylene content of 85 mol %, a butene content of 15 mol %, a melting point (Tm) of 96° C., an MFR (at a temperature of 230° C., under a load of 2.16 kg) of 7 g/10 min. and a molecular weight distribution (Mw/Mn) of 2.1.

(C1) Ethylene/1-Butene Random Copolymer

An ethylene/1-butene copolymer (Trade Name; TAFMER A-4085, manufactured by Mitsui Chemicals, Inc.) has a melting point (Tm) of 67° C. and an MFR (at a temperature of 190° C., under a load of 2.16 kg) of 3.6 g/10 min.

### Example 1

<Sheet Comprising Polypropylene Resin Composition>

A polypropylene (A) and a propylene/1-butene random copolymer (B) were dry-blended (at blending quantities described in Table 1 using a Henschel mixer, and the resulting polypropylene resin composition was film-formed at an extrusion temperature of 210° C. and at a chill roll temperature of 30° C. using an extruder equipped with a T-die to obtain a sample of sheet having a thickness of 0.6 mm.

<Vacuum Molding>

The sample of sheet obtained above was vacuum molded under the conditions of a preheater temperature of 250° C., a preheating time of 15 sec., a die temperature of 20° C. and a residence time in the die of 10 sec. using a vacuum molder equipped with a cup-shaped die having a bore diameter of 80 mm and a depth of 40 mm.

Table 1 shows the results of evaluation of heat resistance as measured in terms of the deflection temperature under load using a test specimen, sheet moldability, haze of the sheet, vacuum moldability (softening state and blanching state) and haze of the molded articles obtained by vacuum molding.

<Bending Workability>

By using the sheet sample obtained above, as shown in FIG. 1, the shape retention property at bending processing was evaluated by measuring a return angle (θ degree) when the force is released after bending and holding the sheet at an angle of 90 degree at room temperature for 5 minutes.

### Examples 2 and 3 and Comparative Example 1

A sample of sheet was obtained in the same manner as in Example 1 except that the blending ratio of the propylene polymer (A) and the propylene/1-butene random copolymer (B) was set to the composition described in Table 1.

Then, the resulting sheet sample was vacuum molded and bend-processed.

Table 1 shows the results of evaluation of physical properties, performed in the same manner as in Example 1.

### Example 4

A sample of sheet was obtained in the same manner as in Example 1 except that (A2) was used as a propylene polymer (A).

Then, the obtained sample of sheet was vacuum molded and bend-processed.

Table 1 shows the results of evaluation of physical properties, performed in the same manner as in Example 1.

### Example 5

A sample of sheet was obtained in the same manner as in Example 2 except that (B2) was used as a propylene/α-olefin copolymer (B).

Then, the obtained sample of sheet was vacuum molded and bend-processed.

Table 1 shows the evaluation results of physical properties which was performed in the same manner as in Example 1.

### Example 6

A sample of sheet was obtained in the same manner as in Example 2 except that (B3) was used as a propylene/α-olefin copolymer (B).

Then, the obtained sheet was vacuum molded and bend-processed.

Table 1 shows the results of evaluation of physical properties, performed in the same manner as in Example 1.

### Comparative Example 2

A sample of sheet was obtained in the same manner as in Example 1 except that (C1) ethylene/1-butene copolymer was used in place of the propylene/α-olefin copolymer (B) and the blending ratio was set to the composition described in Table 1.

Then, the obtained sheet was vacuum molded and bend-processed.

Table 1 shows the results of evaluation of physical properties, performed in the same manner as in Example 1.

TABLE 1

| | | | Example | Example | Example | Example | Example | Example | Comparative | Comparative |
|---|---|---|---|---|---|---|---|---|---|---|
| | | | 1 | 2 | 3 | 4 | 5 | 6 | Example 1 | Example 2 |
| Propylene polymer (A) | | Resin type | A1 | A1 | A1 | A2 | A1 | A1 | A1 | A1 |
| | | % by weight | 99 | 95 | 80 | 99 | 95 | 95 | 100 | 95 |
| Propylene/α-olefin | | Resin type | B1 | B1 | B1 | B1 | B2 | B3 | — | C1 |
| copolymer (B) | | % by weight | 1 | 5 | 20 | 1 | 5 | 5 | 0 | 5 |
| Deflection temperature | | Degree | 110 | 95 | 90 | 85 | 100 | 103 | 115 | 85 |
| under load (0.45 MPa) | | ° C. | | | | | | | | |
| Moldability of sheet | | — | ◯ | ◯ | ◯ | ◯ | ◯ | ◯ | ◯ | ◯ |
| Haze of sheet | | % | 47 | 49 | 45 | 3.2 | 50 | 51 | 62 | 55 |
| Vacuum | Softening | — | Good | Good | Good | Good | Good | Good | Good | Good |
| moldability | State | | | | | | | | | |
| | Blanching | — | ◯ | ◯ | ◯ | ◯ | ◯ | Δ | X | X |
| | Stare | | | | | | | | | |

| | | | | | | | | | |
|---|---|---|---|---|---|---|---|---|---|
| Haze of molded articles | % | 30.2 | 10.3 | 4.5 | 2.5 | 11.6 | 14.8 | 50 | 41.6 |
| Shape retention property | Degree θ | 16 | 12 | 5 | 14 | 15 | 20 | 40 | 18 |

As shown in Examples 1 to 6 in Table 1, the molded article obtained by molding a polypropylene resin composition comprising a propylene polymer (A) and a propylene/α-olefin copolymer (B) has substantially no blanching in thermoforming and is excellent in moldability, heat resistance, transparency, as well as has an excellent shape retention property in bending processing.

Since a container obtained by thermoforming sheet obtained from a polypropylene resin composition of the present invention is excellent in heat resistance, transparency, appearance and shape, it is suitably used as a container for the storage and transportation of, for example, foods such as bean curd, jelly, dairy products like yogurt or frozen foods, as well as electric parts or electronic components. In addition, a molded article obtained by bend-molding a polypropylene resin composition of the present invention is excellent in heat resistance and has an excellent shape retention property in bending processing and thus is suitably used for the application of a molded article accompanying bending processing.

1. A polypropylene resin composition comprising 50 to 99% by weight of a propylene polymer (A) having a melting point (Tm) in the range of 140 to 170° C. as measured by a differential scanning calorimeter and 1 to 50% by weight of a propylene/α-olefin copolymer (B) having a melting point (Tm) of 100° C. or less or having no observed melting point.

2. The polypropylene resin composition according to claim 1, wherein said propylene polymer (A) has a constituent unit derived from propylene and a constituent unit derived from at least one kind of olefin selected from an ethylene and α-olefin having 4 to 20 carbon atoms and the content of the constituent unit derived from ethylene and α-olefin having 4 to 20 carbon atoms is 3.5 mol % or less.

3. The polypropylene resin composition according to claim 1, wherein said propylene polymer (A) is a propylene homopolymer.

4. The polypropylene resin composition according to claim 1, wherein said propylene/α-olefin copolymer (B) contains a constituent unit derived from propylene in 65 to 79 mol % and a constituent unit derived from 1-butene in 21 to 35 mol %.

5. The polypropylene resin composition according to claim 1, wherein said polypropylene resin composition is used for thermoforming.

6. A film or sheet having a thickness of 0.05 to 5 mm formed from said polypropylene resin composition for thermoforming according to claim 5.

7. A container obtained by thermoforming the film or sheet according to claim 6.

8. The polypropylene resin composition according to claim 1, wherein a sheet having 0.6 mm thickness obtained by forming the polypropylene resin composition has a return angle (θ degree) of 30 degree or less when the force is released after bending and holding the sheet at an angle of 90 degree at room temperature for 5 minutes.

9. A molded article obtained by bending processing a film or sheet obtained from the polypropylene resin composition according to claim 1.
